(19) United States
(12) Patent Application Publication
(10) Pub. No.: US 2026/0112073 A1
(43) Pub. Date: Apr. 23, 2026

(54) TEXT-DRIVEN DIFFUSION MODEL FOR ENHANCED IMAGE GENERATION

(71) Applicant: INTERNATIONAL BUSINESS MACHINES CORPORATION, ARMONK, NY (US)

(72) Inventors: Xue Yin Zhuang, Beijing (CN); Ze Ming Zhao, Beijing (CN); Xiao Tian Xu, Beijing (CN)

(21) Appl. No.: 18/921,154

(22) Filed: Oct. 21, 2024

(51) Int. Cl. G06T 11/00

(52) U.S. Cl. CPC G06T 11/00

(57) ABSTRACT

According to one embodiment, a method, computer system, and computer program product for detail-enhanced text-to-image generation is provided. The present invention may include retrieving a text prompt; processing the text prompt through a trained region of interest model to recognize and extract one or more portions of text in the text prompt representing key details of the text prompt; processing the text prompt and the one or more portions of text in the text prompt representing key details of the text prompt through a pre-trained large language model to generate a plurality of structured text prompts; arranging the plurality of structured text prompts into a retrospective text sequence using an interleaved retrospective algorithm; and processing the retrospective text sequence through a trained progressive text-driven diffusion model to generate a detail-enhanced image representing the text prompt.

### BACKGROUND

The present invention relates, generally, to the field of computing, and more particularly to computer vision and natural language processing.

Computer vision focuses on enabling computers to identify and understand objects and people in images and videos. Meanwhile, natural language processing focuses on enabling computers to understand and communicate with human language. More specifically, both computer vision and natural language processing use machine learning to teach computers and systems to derive meaningful information from visual and text inputs, respectively, and to make recommendations or take action based on the derived information. One particular application of computer vision and natural language processing includes text-to-image generation using machine learning models, i.e. creating images from textual descriptions.

### SUMMARY

Embodiments of a method, a computer system, and a computer program product for detail-enhanced text-to-image generation are described. According to one embodiment, a method, computer system, and computer program product for detail-enhanced text-to-image generation may comprise retrieving a text prompt; processing the text prompt through a trained region of interest model to recognize and extract one or more portions of text in the text prompt representing key details of the text prompt; processing the text prompt and the one or more portions of text in the text prompt representing key details of the text prompt through a pre-trained large language model to generate a plurality of structured text prompts; arranging the plurality of structured text prompts into a retrospective text sequence using an interleaved retrospective algorithm; and processing the retrospective text sequence through a trained progressive text-driven diffusion model to generate a detail-enhanced image representing the text prompt.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating a text-driven enhanced image generation process according to at least one embodiment.

FIG. 3 is an illustration of a text-driven enhanced image generation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of computing, in particular to computer vision and natural language processing, and more specifically to text-to-image generation using multiple machine learning models. The present embodiment can perform detail-enhanced text-to-image generation by processing text with no restrictions on the character length of the input text. More specifically, the present embodiment can recognize and extract key details in a text prompt using a trained text-region of interest model, arrange portions of extracted text from the text prompt into a retrospective text sequence using an interleaved retrospective algorithm, and generate a detail-enhanced image representing a text prompt using a trained progressive text-driven diffusion model.

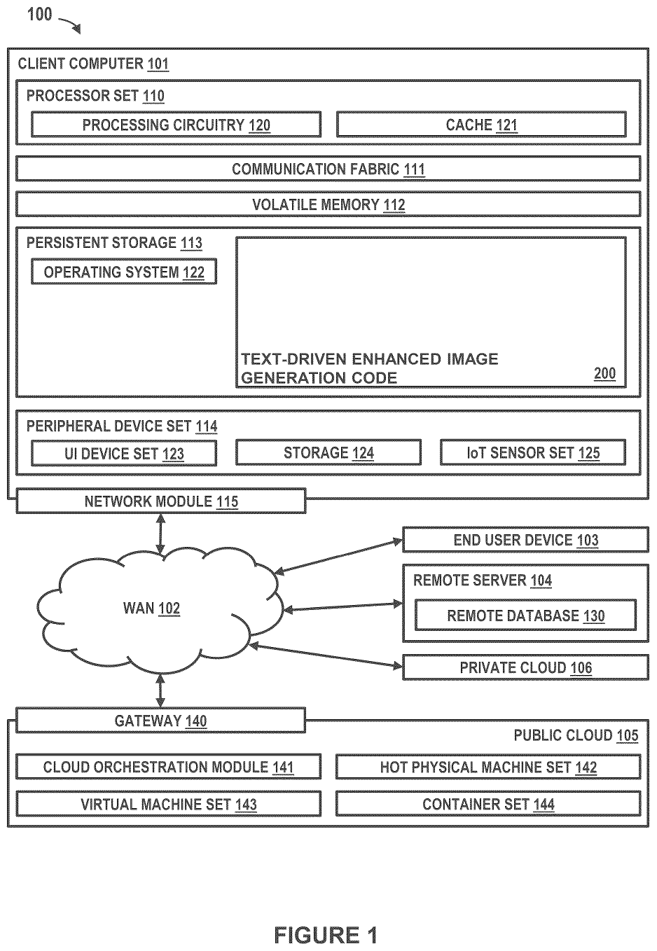

The embodiments mentioned in this paragraph are further illustrated and described below in the discussions of FIGS. 1, 2, and 3. According to at least one embodiment, the text-driven enhanced image generation program retrieves a text prompt. Also, the program processes the text prompt through a trained region of interest model to recognize and extract one or more portions of text in the text prompt representing key details of the text prompt. Additionally, the program processes the text prompt and the one or more portions of text in the text prompt representing key details of the text prompt through a pre-trained large language model to generate a plurality of structured text prompts. Furthermore, the program arranges the plurality of structured text prompts into a retrospective text sequence using an interleaved retrospective algorithm. Moreover, the program processes the retrospective text sequence through a trained progressive text-driven diffusion model to generate a detail-enhanced image representing the text prompt.

Thus, embodiments of the present invention may provide advantages including, but not limited to, increasing the accuracy and applicability of text-to-image generation using machine learning models. The present invention extracts and arranges portions of text from an input text into a retrospective text sequence, thereby capturing and preserving the key details and high-level summarization information of the text. Also, the present invention performs text-to-image generation by processing the retrospective text sequence through a trained diffusion model, thereby improving the performance of text-to-image generation while overcoming character limitations in the processing of input text. The present invention does not require that all advantages need to be incorporated into every embodiment of the invention.

According to at least one other embodiment, the trained region of interest model comprises a pre-trained Bidirectional Encoder Representations from Transformers (BERT) language model with a classifier built on top of the BERT language model. In this embodiment, the trained region of interest model has the advantage of recognizing and extracting one or more portions of text in an input text prompt representing key details of the text prompt.

According to at least one other embodiment, the program trains the classifier within the region of interest model using training data to perform the recognizing and the extracting of the one or more portions of text in the text prompt representing key details of the text prompt. In this embodiment, the training process has the advantage of training a region of interest model to learn to both recognize and extract one or more portions of text in an input text prompt representing key details of the text prompt.

According to at least one other embodiment, the program trains the progressive text-driven diffusion model using training data via a classifier-free guidance process to perform the generating of the detail-enhanced image representing the text prompt. In this embodiment, the training process has the advantage of training a diffusion model to learn to generate detail-enhanced images representing input text prompts.

According to at least one other embodiment, the plurality of structured text prompts comprises a plurality of key details text prompts and a plurality of high-level summary information text prompts. In this embodiment, the plurality of structured text prompts has the advantage of comprising both key details of a text prompt and high-level summarization details of the text prompt.

According to at least one other embodiment, the retrospective text sequence comprises each of the plurality of the key details text prompts and at least one of each of the plurality of high-level summary information text prompts. In this embodiment, the retrospective text sequence has the advantage of not losing previously processed details during the diffusion process.

According to at least one other embodiment, the trained progressive text-driven diffusion model can process a retrospective text sequence of any character length. In this embodiment, the trained progressive text-drive diffusion model has the advantage of overcoming character limits in a text-to-image diffusion process.

Currently, various machine learning models exist that can perform text-to-image generation, such as DALL-E2 and DALL-E3. However, those machine learning models are limited in that they can only process text up to a certain character length, 1,000 characters and 4,000 characters, respectively. Thus, if machine learning models are limited in the length of text they can process, their range of applicability in text-to-image generation remains limited. Additionally, these machine learning models remain susceptible to losing text details the longer the inputted text gets, increasing the likelihood that a generated image is not fully representative of inputted text, and, as a result, is inaccurate. Therefore, a detail-enhanced implementation of a text-to-image generation process is needed, in which extracted portions of text from an input text are arranged into a retrospective text sequence and images are generated using the retrospective text sequence.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to retrieve a text prompt, process the text prompt through a trained region of interest model to recognize and extract one or more portions of text in the text prompt representing key details of the text prompt, process the text prompt and the one or more portions of text in the text prompt representing key details of the text prompt through a pre-trained large language model to generate a plurality of structured text prompts, arrange the plurality of structured text prompts into a retrospective text sequence using an interleaved retrospective algorithm, and process the retrospective text sequence through a trained progressive text-driven diffusion model to generate a detail-enhanced image representing the text prompt.

Referring to FIG. 1, an exemplary networked computer environment 100 is depicted, according to at least one embodiment. Computing environment 100 contains an example of an environment for the execution of at least some of the computer code involved in performing the inventive methods, such as text-driven enhanced image generation code 200, also referred to as “text-driven enhanced image generation program 200”, or “the program 200”. In addition to code block 200 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 may comprise a knowledge corpus, whereby the knowledge corpus is maintained by the program 200. The knowledge corpus may store collected and organized training data. The knowledge corpus can access one or more publicly available resources, such as, but not limited to, book repositories, scientific research repositories, and crawled data from the internet. The training data can comprise text, for example, text prompts, and images, for example, images representing the text prompts. The text prompts may comprise key details. Key details may comprise keywords and/or sentences, and/or part(s) of a sentence, that have significant effects on a generated image's, via text-to-image generation, style and quality, such as objects, locations, descriptions of settings, for example, lighting or decorations, descriptions of people, for example, facial expressions or gestures, etc. Also, the text prompts can comprise high-level summary information, such as composition, topic, view, background, subject, etc. The database 130 can store outputted data from the machine learning models, such as structured text prompts, retrospective text sequences, and detail-enhanced generated images. Also, the database 130 can store the trained neural networks and machine learning models.

The progressive text-driven diffusion model can be a generative deep learning neural network. At a minimum, the progressive text-driven diffusion model can comprise a denoising architecture, such as a U-Net architecture or a modified U-Net architecture, that comprises an embedder, one or more ResNet blocks, one or more downsample blocks, one or more self-attention blocks, one or more upsample blocks, and an output layer. Additionally, the progressive text-driven diffusion model may comprise one or more skip connections between the blocks in the progressive text-driven model. The progressive text-driven diffusion model may use skip connections to directly feed the output of one layer as input into a further layer.

The text region of interest (“ROI”) model, otherwise referred to as the ROI model, can be a transformer-based token classification model, for example, a pre-trained Bidirectional Encoder Representations from Transformers (“BERT”) language model with a classifier built on top of it. The natural language processing (“NLP”) model can be a pre-trained large language model (“LLM”) that can summarize a text prompt, and determine the framework, context, and structure of a text prompt.

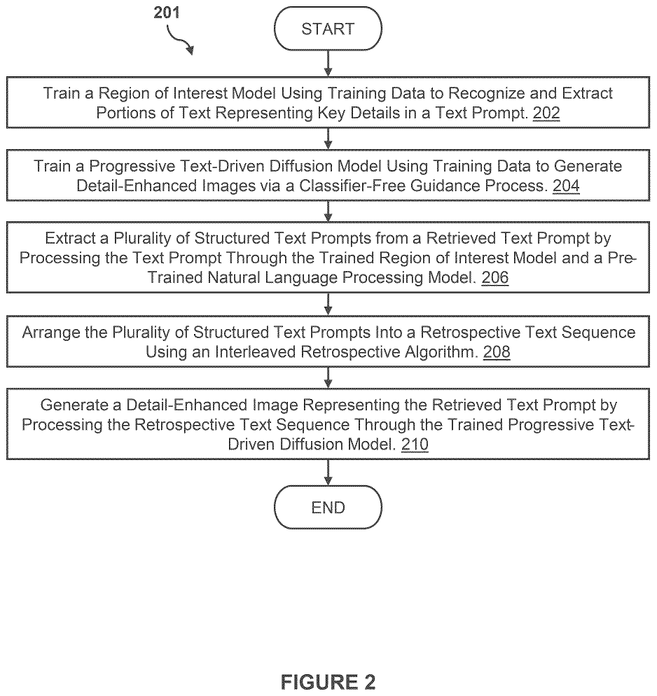

According to the present embodiment, the text-driven enhanced image generation program 200 may be a program capable of retrieving a text prompt. Also, the program 200 may be a program capable of processing the text prompt through a trained region of interest model to recognize and extract one or more portions of text in the text prompt representing key details of the text prompt. Additionally, the program 200 may be a program capable of processing the text prompt and the one or more portions of text in the text prompt representing key details of the text prompt through a pre-trained large language model to generate a plurality of structured text prompts. Moreover, the program 200 may be a program capable of arranging the plurality of structured text prompts into a retrospective text sequence using an interleaved retrospective algorithm. Furthermore, the program 200 may be a program capable of processing the retrospective text sequence through a trained progressive text-driven diffusion model to generate a detail-enhanced image representing the text prompt. The program 200 may be located on client computing device 101 or remote server 104 or on any other device located within network 102. Furthermore, the program 200 may be distributed in its operation over multiple devices, such as client computing device 101 and remote server 104. The text-driven enhanced image generation method is explained in further detail below with respect to FIG. 2.

Referring now to FIG. 2, an operational flowchart illustrating a text-driven enhanced image generation embedding process 201 is depicted according to at least one embodiment. At 202, the program 200 trains the ROI model using training data to recognize and extract portions of text in a text prompt representing key details in the prompt. The ROI model may be trained on a large corpus of labeled text data, i.e. the text data comprised within the training data. The labeled text data may be annotated with descriptions of the key details. The program 200 can access and retrieve the labeled text data from the knowledge corpus within the database 130. The program 200 can group the labeled text data into a dataset and input the dataset into the ROI model. The ROI model can preprocess the dataset through the pre-trained BERT language model to embed the text data, and, as a result, capture the features of the text. The program 200 can train the classifier by feeding the text embeddings into the classifier built on top of the pre-trained BERT language model. By learning the text embeddings, the classifier can be taught to recognize and label portions of text in a text prompt representing key details in the text based on the values of the embedded tokens of the text prompt. The trained classifier, and thus, the trained ROI model, can output labeled text representing the key details in an inputted text prompt.

At 204, the program 200 trains the progressive text-driven diffusion neural network, also referred to as the diffusion model, using the training data to generate detail-enhanced images via a classifier-free guidance process. The diffusion model may be trained on a large corpus of labeled image data, i.e. the image data comprised within the training data. The labeled image data may be annotated with text descriptions detailing the key details and the high-level summary information. The program 200 can access and retrieve the labeled image data from the knowledge corpus within the database 130. The program 200 can input the labeled image data into the diffusion model. During the training of the progressive text-driven diffusion model, the program 200 can use a forward and backward, also referred to as reverse, diffusion process to train the diffusion model. The program 200 can train the diffusion model using a forward diffusion process, in which Gaussian noise is progressively added via a Markov chain to the input labeled image data until the images are transformed to pure Gaussian noise. The program 200 can train the diffusion model using a reverse diffusion process, in which images with pure Gaussian noise are iteratively denoised via a plurality of small denoising steps to recreate the original labeled image data, to teach the diffusion model to denoise noisy data by predicting the noise at each step of the diffusion process.

More specifically, the program 200 trains the diffusion model using a classifier-free guidance to function both as a conditional model and as an unconditional model by learning the conditional probability distribution, P(xₜ₋₁|xₜ), thus enabling the trained diffusion model to reverse the learned diffusion process in order to generate new data, i.e. sample random Gaussian noise and denoise it to generate an image from the learned conditional probability distribution. The diffusion neural network learns the conditional probability as:

$$P ( {x}_{t - 1} \vert {x}_{t} ) = ‖ ε - ( {f}_{θ} ( {x}_{t} , t , ∅ ) ) + s * ( {f}_{θ} ( ( {x}_{t} , t , S [ t ] ) ) - ( {f}_{θ} ( {x}_{t} , t , ∅ ) ) ‖$$

Gaussian noise can be represented by ε. The final generated image can be represented as x_{T}, which comprises the same dimensionality as x₀, the original image. The length of the retrospective text sequence can be equal to step T. A retrospective text sequence, S[t], can be used as the condition during training. An image at the current time step, t, can be represented by xₜ. An image with less Gaussian noise can be represented by xₜ₋₁. The time step can be represented by t. The predicted noise at time step, t, can be represented by (f_{θ}(xₜ, t, Ø))+s*(f_{θ}((xₜ, t, S[t]))−(f_{θ}(xₜ, t, Ø)), wherein f_{θ}(xₜ, t, Ø) and f_{θ}((xₜ, t, S[t]) can represent parameters. A scaling factor can be represented by s.

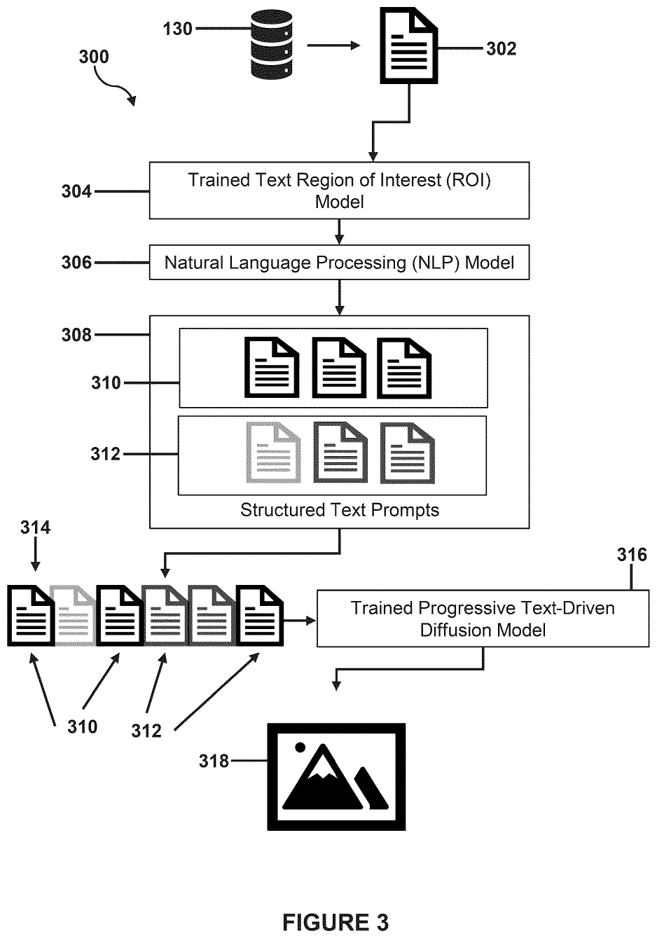

At 206, the program 200 extracts a plurality of structured text prompts 308 (FIG. 3) from a retrieved text prompt 302 (FIG. 3) by processing the retrieved text prompt 302 through the trained ROI model 304 (FIG. 3) and the pre-trained NLP model 306 (FIG. 3). The program 200 may retrieve a text prompt 302, such as a passage from a book, scientific report, etc., as well as any other form of generated text, from the database 130 (FIG. 3), whereby the text prompts are stored, organized, and maintained. The program 200 can group the retrieved text prompt 302 into a dataset and input the dataset into the trained ROI model 304. The trained ROI model 304 can preprocess the dataset through the pre-trained BERT language model to embed the text prompt 302, and, as a result, capture the features of the text prompt 302. The program 200 can feed the text embeddings of the text prompt into the trained classifier built on top of the pre-trained BERT language model to recognize and label portions of the text in the text prompt 302 representing key details in the text based on the values of the embedded tokens of the text prompt. The trained ROI model 304 can output labeled text representing the key details in the inputted text prompt.

Additionally, the program 200 can feed the labeled text representing the key details in the retrieved text prompt and the original retrieved text prompt 302 into the pre-trained NLP model 306. The NLP model 306 can process the labeled text representing the key details in the retrieved text prompt and the original retrieved text prompt 302 to generate a plurality of structured text prompts 308 (FIG. 3). The plurality of structured text prompts 308 may comprise shorter portions of text from the text prompt that detail the high-level summary information 310 (FIG. 3) and the key details 312 (FIG. 3). For example, a high-level summary information text prompt 310 may comprise text extracted from the retrieved text prompt 302, such as text representing a subject, for example, a night sky, with descriptions of the subject and other elements in the text prompt, including all keywords, in a single shortened sentence. Additionally, for example, a high-level summary information text prompt 310 may comprise text extracted from the retrieved text prompt 302, such as text describing the subject, for example, a night sky, with the main details and all related keywords in the text prompt, in a single shortened sentence. Also, for example, a key details text prompt 312 may comprise text extracted from the retrieved text prompt 302 that describes the subject, for example, the night sky, with all the details in the text prompt relating to the subject, in multiple sentences. The NLP model 306 may generate a key details text prompt 312 either verbatim from the retrieved text prompt 302 or by refining/rewording the key details extracted by the trained text ROI model 304 into a coherent text considering the semantics/framework/context of the text prompt 302. The NLP model 306 can output encodings of the plurality of structured text prompts.

At 208, the program 200 arranges the plurality of structured text prompts 308 into a retrospective text sequence 314 (FIG. 3) using an interleaved retrospective algorithm. A retrospective text sequence 314 can be an ordered sequence of the outputted key details text prompts 312 and the high-level summary information text prompts 310. A retrospective text sequence 314 can comprise each of the outputted key details text prompts 312, as well as at least one of each of the outputted high-level summary information text prompts 310. An example retrospective text sequence 314 may comprise, in order, a first high-level summary information text prompt, a second high-level summary information text prompt, a first key details text prompt, a second key details text prompt, the first high-level summary information text prompt inserted a second time, the second high-level summary information text prompt inserted a second time, a third key details text prompt, and a fourth key details text prompt. By inserting high-level summary information text prompts 310 more than once into the retrospective text sequence 314, the program 200 can ensure that all the information comprised within the retrieved text prompt 302 will be inputted into the trained diffusion model 318 (FIG. 3) independent of the length of the retrospective text sequence 314.

The program 200 can begin the retrospective text sequence 314 by inputting each of the high-level summary information text prompts 310 into the initial positions in the sequence 314, respectively. Thereafter, the program 200 can apply an interleaved multi-step retrospective algorithm at each position, k, along the retrospective text sequence 314, to determine whether to insert a key details text prompt 312 or one of the previously inserted high-level summary information text prompts 310, using the following equation:

$${P}_{ret} ( k ) = \{ \begin{matrix}( α * k ) * ( 1 - {e}^{β * ( k - max ( 0 , last\_rev ) ) ; ( K - k ) > len ( remain\_seq )} \\ 0 ; ( K - k ) \leq len ( remain\_seq )\end{matrix}$$

The parameter, ranging from 0 to 1, which controls the probability of inserting a previously inserted high-level summary information text prompt 310 can be represented by α. The parameter, greater than 0, which controls the degree to which a position in the retrospective text sequence 314 influences the probability of inserting a previously inserted high-level summary information text prompt 310 can be represented by β. The position of the previously inserted high-level summary information text prompt 310 in the retrospective text sequence 314 can be represented by last_rev. In cases where there is not a previously inserted high-level summary information text prompt 310 before the current position in the retrospective text sequence 314, j=0. At each position, the program 200 can determine to insert a key details text prompt 312 if Pᵣₑₜ(k) is less than or equal to a preset threshold. Likewise, the program 200 can determine to insert a previously inserted high-level summary information text prompt 310 if Pᵣₑₜ(k) exceeds a preset threshold. This process, with the preset threshold set to 0.5, is shown below:

$$\{ \begin{matrix}Next ( ori\_seq ) ; {P}_{ret} ( k ) < 0.5 \\ Max ( {R}_{i , k} ) ; {P}_{ret} ( k ) \geq 0.5\end{matrix}$$

If the program 200 determines to insert a previously inserted high-level summary information text prompt 310 into the current position in the retrospective text sequence 314, the program 200 can determine which of the previously inserted high-level summary information text prompts 310 to insert into the current position using the following equation:

$${R}_{i , k} = \frac{( 1 - {γ}_{i} ) * {e}^{- σ * i}}{{\sum }_{j = 0}^{m - 1} ( 1 - {γ}_{j} ) * {e}^{- σ * j}}$$

The normalized value of the number of times high-level summary information text prompt i has been inserted into the retrospective text sequence 314, i.e. the number of times i has been inserted divided by the total number of high-level summary information text prompts 310, can be represented by γᵢ. The parameter, greater than 0, which controls the degree to which the high-level summary information text prompt index influences the high-level summary information text prompt probability can be represented by σ. The program 200 can choose to insert the high-level summary information text prompt with the highest R_{i,k} value.

The program 200 can end the retrospective text sequence 314 upon each of the outputted key details text prompts 312 having been inserted into the retrospective text sequence 314. The retrospective text sequence 314, comprising the encodings of the structured text prompts 308, can be represented by S.

At 210, the program 200 generates a detailed-enhanced image 318 (FIG. 3) representing the retrieved text prompt 302 by processing the encodings of the retrospective text sequence, S, 314 through the trained progressive text-driven diffusion model 316 (FIG. 3). The program 200 can input the encodings of the retrospective text sequence, S, 314 in a stepwise manner into the trained progressive text-driven diffusion model 316 and process the retrospective text sequence, S, 314 alongside randomly sampled Gaussian noise. The trained diffusion model 316 can reverse the learned diffusion process to denoise the randomly sampled Gaussian noise using the learned conditional probability distribution and S[t] as guidance for step t prediction, until step T is complete, to generate the detailed-enhanced image 318 representing the retrieved text prompt 302. As previously stated, the length of the retrospective text sequence, S, 314 is equal to step T. Thus, after processing the retrospective text sequence, S, 314 through the trained diffusion model 316, the trained diffusion model 316 may output the detailed-enhanced image 318 (FIG. 3) representing the retrieved text prompt 302. The program 200 can display the detailed-enhanced image 318 on one or more client computing devices 101 through a graphical user interface (“GUI”).

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detail-enhanced text-to-image generation, the method comprising:
retrieving a text prompt;
processing the text prompt through a trained region of interest model to recognize and extract one or more portions of text in the text prompt representing key details of the text prompt;
processing the text prompt and the one or more portions of text in the text prompt representing key details of the text prompt through a pre-trained large language model to generate a plurality of structured text prompts;
arranging the plurality of structured text prompts into a retrospective text sequence using an interleaved retrospective algorithm; and
processing the retrospective text sequence through a trained progressive text-driven diffusion model to generate a detail-enhanced image representing the text prompt.

2. The method of claim 1, wherein the trained region of interest model comprises a pre-trained Bidirectional Encoder Representations from Transformers (BERT) language model with a classifier built on top of the BERT language model.

3. The method of claim 2, further comprising:
training the classifier within the region of interest model using training data to perform the recognizing and the extracting of the one or more portions of text in the text prompt representing key details of the text prompt.

4. The method of claim 1, the method further comprising:
training the progressive text-driven diffusion model using training data via a classifier-free guidance process to perform the generating of the detail-enhanced image representing the text prompt.

5. The method of claim 1, wherein the plurality of structured text prompts comprises a plurality of key details text prompts and a plurality of high-level summary information text prompts.

6. The method of claim 5, wherein the retrospective text sequence comprises each of the plurality of the key details text prompts and at least one of each of the plurality of high-level summary information text prompts.

7. The method of claim 1, wherein the trained progressive text-driven diffusion model can process a retrospective text sequence of any character length.

8. A computer system for detail-enhanced text-to-image generation, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
retrieving a text prompt;
processing the text prompt through a trained region of interest model to recognize and extract one or more portions of text in the text prompt representing key details of the text prompt;
processing the text prompt and the one or more portions of text in the text prompt representing key details of the text prompt through a pre-trained large language model to generate a plurality of structured text prompts;
arranging the plurality of structured text prompts into a retrospective text sequence using an interleaved retrospective algorithm; and
processing the retrospective text sequence through a trained progressive text-driven diffusion model to generate a detail-enhanced image representing the text prompt.

9. The computer system of claim 8, wherein the trained region of interest model comprises a pre-trained Bidirectional Encoder Representations from Transformers (BERT) language model with a classifier built on top of the BERT language model.

10. The computer system of claim 9, further comprising:
training the classifier within the region of interest model using training data to perform the recognizing and the extracting of the one or more portions of text in the text prompt representing key details of the text prompt.

11. The computer system of claim 8, the method further comprising:
training the progressive text-driven diffusion model using training data via a classifier-free guidance process to perform the generating of the detail-enhanced image representing the text prompt.

12. The computer system of claim 8, wherein the plurality of structured text prompts comprises a plurality of key details text prompts and a plurality of high-level summary information text prompts.

13. The computer system of claim 12, wherein the retrospective text sequence comprises each of the plurality of the key details text prompts and at least one of each of the plurality of high-level summary information text prompts.

14. The computer system of claim 8, wherein the trained progressive text-driven diffusion model can process a retrospective text sequence of any character length.

15. A computer program product for detail-enhanced text-to-image generation, the computer program product comprising:
one or more computer-readable tangible storage medium and program instructions stored on at least one of the one or more tangible storage medium, the program instructions executable by a processor to cause the processor to perform a method comprising:
retrieving a text prompt;
processing the text prompt through a trained region of interest model to recognize and extract one or more portions of text in the text prompt representing key details of the text prompt;
processing the text prompt and the one or more portions of text in the text prompt representing key details of the text prompt through a pre-trained large language model to generate a plurality of structured text prompts;
arranging the plurality of structured text prompts into a retrospective text sequence using an interleaved retrospective algorithm; and
processing the retrospective text sequence through a trained progressive text-driven diffusion model to generate a detail-enhanced image representing the text prompt.

16. The computer program product of claim 15, wherein the trained region of interest model comprises a pre-trained Bidirectional Encoder Representations from Transformers (BERT) language model with a classifier built on top of the BERT language model.

17. The computer program product of claim 16, further comprising:
training the classifier within the region of interest model using training data to perform the recognizing and the extracting of the one or more portions of text in the text prompt representing key details of the text prompt.

18. The computer program product of claim 15, the method further comprising:
training the progressive text-driven diffusion model using training data via a classifier-free guidance process to perform the generating of the detail-enhanced image representing the text prompt.

19. The computer program product of claim 15, wherein the plurality of structured text prompts comprises a plurality of key details text prompts and a plurality of high-level summary information text prompts.

20. The computer program product of claim 19, wherein the retrospective text sequence comprises each of the plurality of the key details text prompts and at least one of each of the plurality of high-level summary information text prompts.
